(19) United States
(12) Patent Application Publication
(10) Pub. No.: US 2026/0190070 A1
(43) Pub. Date: Jul. 2, 2026

(54) INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Yang SHEN, Beijing (CN)

(21) Appl. No.: 19/128,340

(22) PCT Filed: Nov. 10, 2022
(86) PCT No.: PCT/CN2022/131237

§ 371 Date: May 8, 2025

(51) Int. Cl. H04W 64/00; H04W 4/40; H04W 28/02; H04W 92/18

(52) U.S. Cl. CPC H04W 64/00; H04W 4/40; H04W 28/0268; H04W 92/18

(57) ABSTRACT

An information handling method is applied to a terminal device, and includes: mapping first information of a ranging and/or sidelink (SL) positioning service into a quality of service (QOS) parameter, wherein the first information represents a QoS requirement for ranging and/or SL positioning, and wherein the QoS parameter is used to configure or schedule radio bearer (RB) resources.

### CROSS-REFERENCE TO RELATED APPLICATION

This application is the U.S. national phase application of International Application No. PCT/CN 2022/131237, filed on Nov. 10, 2022, the disclosure of which is incorporated herein by reference in its entirety.

### TECHNICAL FIELD

The present disclosure relates to, but is not limited to, the field of wireless communication technologies, and in particular to an information handling method and apparatus, a communication device and a storage medium.

### BACKGROUND

Ranging refers to the determination of a distance between two user equipments (UEs) or more UEs and/or a direction of one UE (i.e. a target UE) from another UE (i.e. a reference UE) via a PC5 interface.

Sidelink (SL) positioning uses the PC5 interface to position a UE to obtain an absolute position, a relative position, or ranging information.

The ranging or the SL positioning is expected to support scenarios such as commercial, vehicle to everything (V2X) and public safety, with different scenarios requiring different quality of service (QOS) treatments.

### SUMMARY

Examples of the present disclosure provide an information handling method and apparatus, a communication device and a storage medium.

A first aspect of the examples of the present disclosure provides an information handling method, which is applied to a terminal device, and the method includes: mapping first information of a ranging service and/or a sidelink (SL) positioning service into a quality of service (QOS) parameter, wherein the first information represents a QoS requirement for ranging and/or SL positioning, and wherein the QoS parameter is to configure or schedule radio bearer (RB) resources.

A second aspect of the examples of the present disclosure provides a communication device, which includes one or more processors, and one or more memories storing an executable program executable by the one or more processors, wherein the one or more processors are configured to map first information of a ranging service and/or SL positioning service into a QoS parameter, wherein the first information represents a QoS requirement for ranging and/or SL positioning, and wherein the QoS parameter is to configure or schedule RB resources.

A third aspect of the examples of the present disclosure provides a non-transitory computer storage medium, storing an executable program, wherein the executable program, when executed by one or more processors, causes the one or more processors to perform:
mapping first information of a ranging service and/or SL positioning service into a QoS parameter, wherein the first information represents a QoS requirement for ranging and/or SL positioning, and wherein the QoS parameter is to configure or schedule RB resources.

It is to be understood that the above general descriptions and the following detailed descriptions are only illustrative and explanatory, and are not intended to limit the examples of the present disclosure.

### BRIEF DESCRIPTION OF THE DRAWINGS

The accompanying drawings, which are incorporated in and constitute a part of this specification, illustrate examples consistent with the examples of the present disclosure and, together with the specification, serve to explain the principles of the examples of the disclosure.

FIG. 1 is a schematic structural diagram illustrating a wireless communication system according to an example.

FIG. 2 is a schematic diagram illustrating that a ranging service is provided to UEs in different scenarios according to an example.

FIG. 3 is a schematic diagram illustrating flow-based QoS model mapping for NR PC5 according to an example.

FIG. 4 is a schematic diagram illustrating a handling of PC5 QoS flows based on PC5 QoS rules according to an example.

FIG. 5 is a schematic diagram illustrating a UE protocol stack for ranging and/or SL positioning according to an example.

FIG. 6 is a schematic flowchart illustrating an information handling method according to an example.

FIG. 7 is a schematic flowchart illustrating an information handling method according to an example.

FIG. 8 is a schematic flowchart illustrating an information handling method according to an example.

FIG. 9 is a schematic flowchart illustrating an information handling method according to an example.

FIG. 10 is a schematic flowchart illustrating an information handling method according to an example.

FIG. 11 is a schematic flowchart illustrating an information handling method according to an example.

FIG. 12 is a schematic flowchart illustrating an information handling method according to an example.

FIG. 13 is a schematic flowchart illustrating an information handling method according to an example.

FIG. 14 is a schematic flowchart illustrating an information handling method according to an example.

FIG. 15 is a schematic flowchart illustrating an information handling method according to an example.

FIG. 16 is a schematic flowchart illustrating an information handling method according to an example.

FIG. 17 is a schematic flowchart illustrating an information handling method according to an example.

FIG. 18 is a schematic flowchart illustrating an information handling method according to an example.

FIG. 19 is a schematic structural diagram illustrating an information handling apparatus according to an example.

FIG. 20 is a schematic structural diagram illustrating a UE according to an example.

FIG. 21 is a schematic structural diagram illustrating a communication device according to an example.

### DETAILED DESCRIPTION OF THE EMBODIMENTS

Examples will be described in detail here with the illustrations thereof illustrated in the drawings. Where the following descriptions involve the drawings, like numerals in different drawings refer to like or similar elements unless otherwise indicated. The implementations described in the following examples do not represent all implementations consistent with the examples of the present disclosure. Rather, they are merely examples of apparatus and methods consistent with some aspects of the examples of the present disclosure.

The terms used in the present disclosure are for the purpose of describing particular examples only, and are not intended to limit the examples of the present disclosure. Terms determined by “a,” “said” and “the” in their singular forms in the present disclosure are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” and the like may be adopted in the examples of the present disclosure to describe various information, such information should not be limited to these terms. These terms are only used to distinguish the information of the same type with each other. For example, without departing from the scope of the examples of the present disclosure, first information may be referred to as second information; and similarly, second information may also be referred to as first information. Depending on the context, the word “if” as used herein may be interpreted as “when,” “upon,” or “in response to determining.”

In the information handling method and apparatus, the communication device and the storage medium provided in the examples of the present disclosure, the information handling method is applied to a terminal device, and maps first information of a ranging and/or SL positioning service into a QoS parameter. The first information represents a QoS requirement for ranging and/or SL positioning, and the QoS parameter is used to configure or schedule RB resources. Therefore, it enables ranging and/or SL positioning QoS treatments in different scenarios.

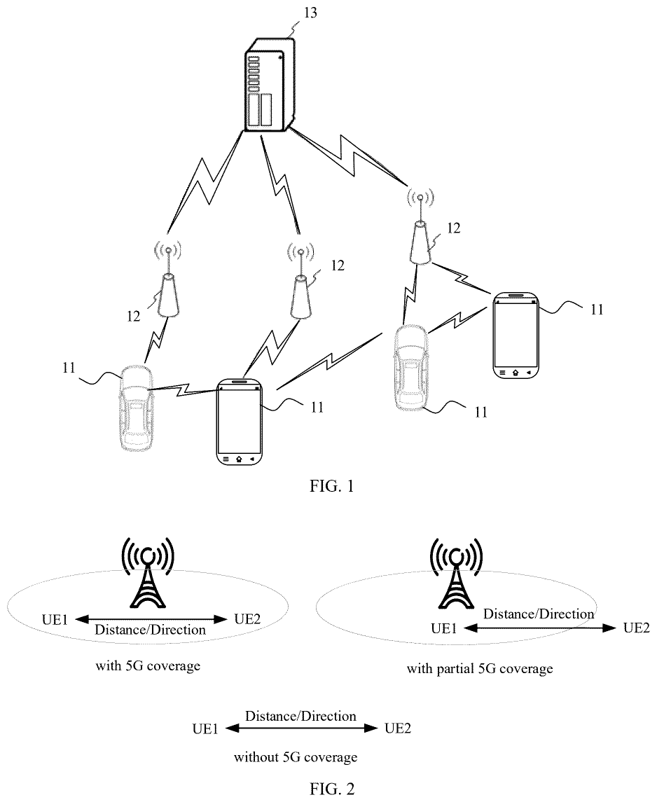

Please refer to FIG. 1, which illustrates a schematic structural diagram of a wireless communication system provided in an example of the present disclosure. As illustrated in FIG. 1, the wireless communication system is based on cellular mobile communication technologies, and may include several user equipments (UEs) 11 and several access network devices 12.

Particularly, the UEs 11 may communicate with one or more core networks via a radio access network (RAN), and may connect to external network devices such as Internet and to other UEs via the one or more core networks. The UE 11 may be an Internet of Things (IOT) UE, such as a sensor device, a mobile phone (or called “cellular” phone) and a computer with the IoT UE, which may be, for example, a fixed, portable, pocket-sized, handheld, computer-built-in, or vehicle-mounted device. For example, the UE 11 may be a station (STA), a subscriber unit, a subscriber station, a mobile station, a mobile, a remote station, an access point, a remote UE, an access UE, a user terminal, a user agent, a user device, or a UE. Alternatively, the UE 11 may be an unmanned aerial vehicle (UAV) device. Alternatively, the UE 11 may be a vehicle-mounted device, for example, a trip computer with a wireless communication function, or a wireless communication device connected externally to the trip computer. Alternatively, the UE 11 may be a roadside device, for example, a street lamp, a signal lamp or another roadside device with a wireless communication function.

The access network device 12 may be a network side device in the wireless communication system. The wireless communication system may be a 4th generation (4G) mobile communication system, which is also known as a long term evolution (LTE) system. Alternatively, the wireless communication system may be a 5th generation (5G) system, which is also known as a new radio (NR) system or a 5G NR system. Alternatively, the wireless communication system may be a next-generation system of the 5G system. The access network in the 5G system may be called a new generation-radio access network (NG-RAN).

The access network device 12 may be an evolved access device used in the 4G system (eNB). Alternatively, the access network device 12 may be an access device that adopts a centralized-distributed architecture in the 5G system (gNB). When adopting the centralized-distributed architecture, the access network device 12 usually includes a central unit (CU) and at least two distributed units (DUs). The CU is provided with protocol stacks of a packet data convergence protocol (PDCP) layer, a radio link control (RLC) protocol layer, and a media access control (MAC) layer. The DU is provided with protocol stacks of a physical (PHY) layer. The examples of the present disclosure do not limit the detailed implementations of the access network device 12.

A wireless connection may be established between the access network device 12 and the UE 11 via a radio air interface. In different implementations, the wireless air interface is based on 4G mobile communication network technology standards; or, the wireless air interface is based on 5G mobile communication network technology standards, for example, the wireless air interface is a new radio; or, the wireless air interface may be based on the next-generation mobile communication network technology standards of the 5G.

The communications between the UEs 11 may be carried out through a sidelink (SL), which may support scenarios such as vehicle to vehicle (V2V) communications, vehicle to infrastructure (V2I) communications and vehicle to pedestrian (V2P) communications of vehicle to everything (V2X) communications and device to device (D2D) communications. Particularly, the D2D communication is also called a proximity service (ProSe) communication.

In some examples, the SL may be a unicast bidirectional link between two UEs 11.

In some examples, the SL may be a broadcast link or a groupcast link supporting a multicast SL service between the UEs 11.

In some examples, the UE 11 may also communicate with the access network device 12 via a communication link. For example, the UE 11 may communicate with the access network device 12 within a coverage area of the access network device 12. It is to be understood that the UE 11 outside the coverage area of the access network device 12 may not communicate directly with the access network device 12.

The wireless communication system may further include a core network device 13. Several access network devices 12 are connected to the core network device 13 separately.

As an example, the core network device 13 may be a mobility management entity (MME) in an evolved packet core (EPC) network. Alternatively, the core network device may be an enhanced serving mobile location center (E-SMLC) and the like.

As another example, the core network device 13 may be an access and mobility management function (AMF), a location management function (LMF), a gateway mobile location center (GMLC), a policy control function (PCF), etc. The example of the present disclosure does not limit the implementation form of the core network device 13.

It is to be noted that the network architecture illustrated in FIG. 1 is only an illustration applicable to the examples of the present disclosure and does not constitute a limitation on the scope of applying the examples of the present disclosure.

In order to facilitate understanding by those skilled in the art, the examples of the present disclosure list multiple implementations to clearly describe the technical solutions of the examples of the present disclosure. Of course, those skilled in the art may understand that the multiple examples provided in the examples of the present disclosure may be performed individually, performed by combining with one or more methods in other examples of the examples of the present disclosure, or performed, individually or after the combination, together with some methods in other related technologies, which is not limited in the examples of the present disclosure.

Some of the terms used in the examples of the present disclosure are described below for ease of understanding by those skilled in the art.

A PC5 interface is a reference point (or an interface) for D2D communications through a user plane (U-plane) between wireless transmitting/receiving units for V2X services. In the 3rd generation partnership project (3GPP), the D2D communications are also called the ProSe.

Ranging refers to the determination of a distance between two UEs or more UEs and/or a direction of one UE (i.e. a target UE) from another UE (i.e. a reference UE) via the PC5 interface.

SL positioning uses the PC5 interface to position a UE to obtain an absolute position, a relative position, or ranging information.

An SL reference UE is a UE that supports the positioning for the target UE, e.g., by using one or more SLs to transmit and/or receive reference signals for positioning, to provide positioning-related information, etc. The SL reference UE may be understood as an “anchor UE”.

The target UE is a UE whose distance, direction and/or position is measured with the support from one or more SL reference UEs using the SL in the ranging-based service and SL positioning.

A relative position is a position estimate of a UE relative to another network element or relative to another UE.

A ranging and/or SL positioning service may be supported with or without 5G coverage. FIG. 2 illustrates the ranging service provided to UEs in different scenarios, with 5G coverage, with partial 5G coverage or without 5G coverage. Particularly, a communication between UEs may be performed through a PC5 link, and a communication between a UE and a base station may be performed through a Uu link. If a licensed frequency band is used for the ranging, it is to be fully controlled by the operator.

A QoS handling for LTE based PC5 may be based on a ProSe per-packet priority (PPPP) or a ProSe per-packet reliability (PPPR).

A QoS handling for NR based PC5 may use a QoS model based on a Uu reference point, that is, based on 5G QoS identifiers (5QIs), a range is an additional parameter. The 5QI identifies a QoS category.

For the V2X communications over an NR based PC5 reference point, a PC5 QOS flow is associated with a PC5 QoS rule and a PC5 QoS parameter. The UE may be configured with a set of PC5 QoS parameters to be used for V2X service types.

The PC5 QoS flow is identified by a PC5 QoS flow identifier (PFI). The PC5 QoS flow may be mapped to a sidelink radio bearer (SLRB) of an access stratum (AS).

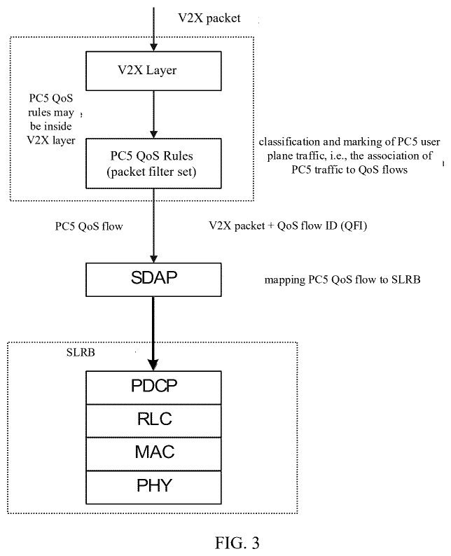

FIG. 3 is an example of flow-based QoS model mapping for NR PC5. As illustrated in FIG. 3, a V2X layer may classify received data packets using a packet filter set. The packet filter set may include the QoS rules for classifying the packets into the PC5 QoS flows. A service data adaptation protocol (SDAP) may map the QoS flow to the SLRB. The SLRB mapped from the QoS flow is passed to a packet data convergence protocol (PDCP), and is handled by an RLC and an MAC to pass to a PHY.

For the V2X communications over the NR PC5 reference point, the PC5 QOS flow is the finest granularity of QoS differentiation in the same destination identified by a destination layer-2 ID. The user plane traffic with the same PFI receives the same traffic forwarding treatment (e.g., scheduling, admission threshold). The PFI is unique within the same destination.

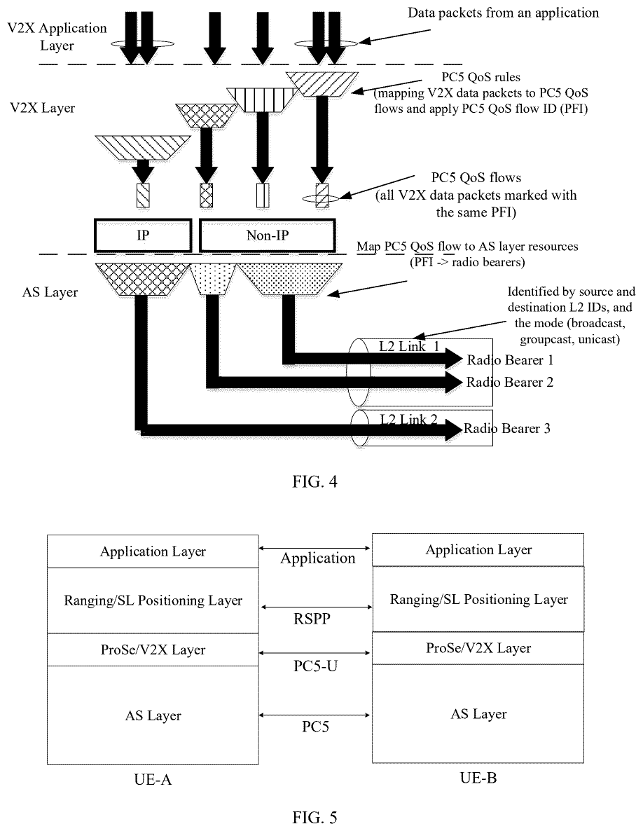

FIG. 4 is a schematic diagram of handling of PC5 QoS flows based on PC5 QoS rules. The drawing illustrates the use of the PC5 QoS rules to classify and mark user plane traffic and map the PC5 QoS flows to radio bearer (RB) resources at the AS layer. As illustrated in FIG. 4, for a given pair of source and destination layer-2 IDs, there may be a plurality of RBs, each corresponding to a different PC5 QoS level. The AS may determine the mapping of the plurality of PC5 QoS flows to the same RB based on the information provided. For a broadcast and groupcast mode communication, the L2 link goes to all UEs in proximity identified by the destination layer-2 ID.

In the examples of the present disclosure, a ranging and/or SL positioning layer is introduced between an application layer and a ProSe/V2X layer of the UE, e.g., the target UE, the reference UE, or an SL positioning server UE, to handle service requests received from the application layer and to control ranging and/or SL positioning operations. A ranging/SL positioning protocol (RSPP) is introduced over the PC5 reference point between the UEs, e.g., the target UE, the reference UE, an assistant UE, a located UE and/or the SL positioning server UE, which includes the following procedures:
1) exchanging a ranging and/or SL positioning capability;
2) exchanging ranging and/or SL positioning assistance data;
3) exchanging ranging and/or SL positioning measurement data/result.

A V2X communication procedure and a 5G ProSe direct communication procedure may be used for the RSPP communications between the UEs over the PC5.

FIG. 5 is a schematic diagram of a UE protocol stack for ranging and/or SL positioning. As illustrated in FIG. 5, the UE protocol stack includes an application layer, a ranging and/or SL positioning layer, a V2X/ProSe layer, and an AS layer. The application layer may receive data packets from various applications executing on the UE and pass the packets to the ranging and/or SL positioning layer. After handled by the ranging and/or SL positioning layer, the packets are passed to the V2X/ProSe layer for final transmission to other UEs.

The “QoS parameter” mentioned in the examples of the present disclosure refer to a “PC5 QoS parameter”.

A ranging and/or SL positioning QoS parameter includes: a target delay and a target accuracy of a ranging and/or SL positioning measurement result (distance and direction), and a range within which the target delay and/or the target accuracy is expected to be achieved.

A QoS parameter of an RSPP data flow refer to a quality of a PC5-U communication for transmitting RSPP flows. For example, it is represented by a QoS flow identifier (QFI), following the V2X and ProSe QoS handling.

For example, the QoS parameter of the RSPP data flow includes at least one of the following: a PC5 5th generation QoS indicator (PQI), a PC5 flow bit rate, a PC5 link aggregation bit rate, or a range. The value of the range may indicate a range to which the PC5 QoS parameter in the PC5 communications is applicable.

For example, the PQI indicates one or more of the following PC5 QoS parameters: a resource type, a priority level, a packet delay budget (PDB), a packet error rate (PER), an averaging window, or a maximum data burst volume (MDBV). Particularly, the resource type may be a guaranteed bit rate (GBR), a delay critical GBR or a non-GBR. QoS requirement information for the ranging and/or SL positioning service include: a target delay and/or a target accuracy of a ranging/SL positioning measurement result, and a range within which the target delay and/or the target accuracy is expected to be achieved.

An application identifier of the ranging and/or SL positioning service is a globally unique identifier identifying a specific ranging and/or SL positioning application. The application identifier may be mapped into second information of a V2X service, for example, mapping the ranging and/or SL application identifier into a V2X service type (which may be referred to as the V2X business type). The application identifier may be mapped into second information of a ProSe service, for example, mapping the ranging and/or SL application identifier into a ProSe service identifier.

The information handling methods provided in the examples of the present disclosure may be applied to a terminal device that supports the ranging and/or SL positioning. The terminal device may include but is not limited to a mobile phone, a drone, a car, a smart home appliance or any IoT device, etc. It is to be understood that the terminal device in the examples of the present disclosure may also be referred to as a terminal or a UE.

In some examples, the terminal device may be a source terminal (i.e., a transmitting side terminal) or a target terminal (i.e., a receiving side terminal). The source terminal may be identified by a source layer-2 ID, and the target terminal may be identified by a destination layer-2 ID.

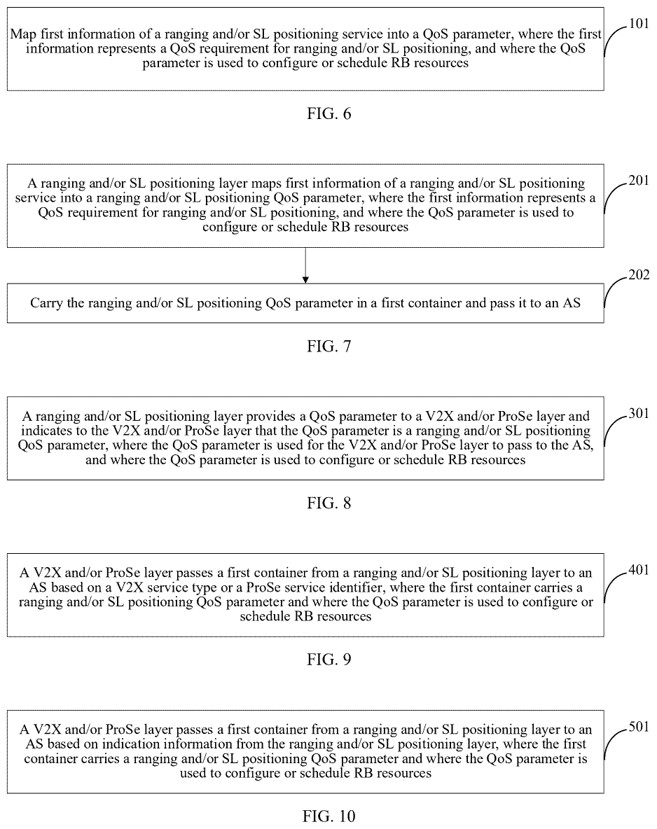

FIG. 6 is a schematic flowchart illustrating an information handling method according to an example. The information handling method is applied to a terminal device. As illustrated in FIG. 6, the information handling method may include the following step.

At step 101, first information of a ranging and/or SL positioning service is mapped into a QoS parameter, where the first information represents a QoS requirement for ranging and/or SL positioning, and where the QoS parameter is used to configure or schedule RB resources.

In some examples, the first information may be carried in a service request for ranging and/or SL positioning. For example, a target UE for ranging and/or SL positioning receives the service request transmitted by a reference UE. The examples of the present disclosure do not specifically limit the service request.

As an example, the service request may be an autonomous driving request. For example, in a short-distance collaborative grouping application scenario in an Internet of Vehicles, a group of cars with a very small adjacent distance (a specified legal distance) form a group that includes a leading car and a plurality of automatic driving following cars. The automatic driving request may request a ranging and/or SL positioning result relative to the leading car, so as to control the autonomous driving of the following car and maintain a legal distance between the cars in the group.

As an example, the service request may be a navigation location request. For example, in a navigation application scenario in a museum, an application server may generate the navigation location request to obtain the distance and the angle of the UE relative to an exhibit to obtain the information on the exhibit that the visitor wants to know. When the visitor walks in and points to a certain exhibit, the UE starts playing guide information of the exhibit.

As an example, the service request may be an object tracking request. For example, in an object tracking application scenario, an object tracking application (APP) on a terminal generates the object tracking request to obtain ranging information (a relative distance and angle) between a drone and the target object, thereby calculating the position of the target object.

In some examples, the QoS requirement may include: a requirement of the ranging and/or SL positioning service for a delay and/or an accuracy of the ranging and/or SL positioning result.

In some other examples, the QoS requirement may refer to a requirement for PC5-U communication quality of transmitting an RSPP data flow. For example, the QoS requirement includes but is not limited to a requirement for jitter, a packet loss rate and/or a bandwidth of the RSPP data flow.

In some examples, the first information of the ranging and/or SL positioning service includes: QoS requirement information of the ranging and/or SL positioning service; and/or, an application identifier of the ranging and/or SL positioning service.

The QoS requirements of different services may be different. The QoS requirement information of the ranging and/or SL positioning service may be used to represent the QoS requirement for ranging and/or SL positioning.

For example, the delay under the QoS requirement corresponding to a service with low delay requirement, such as the automatic driving, is less than the delay under the QoS requirement corresponding to the navigation location service.

The QoS requirements of different ranging and/or SL positioning applications may be different. An application identifier of the ranging and/or SL positioning service may be used to represent the QoS requirement for ranging and/or SL positioning.

It is to be understood that the QoS requirement information and the application identifier of the ranging and/or SL positioning service may also be used together to represent the QoS requirement for ranging and/or SL positioning.

In some examples, in the step 101, the first information of the ranging and/or SL positioning service may be mapped into the QoS parameter by a ranging and/or SL positioning layer of the terminal device. The QoS parameter mapped from the first information is used to configure or schedule RB resources. The RB may be an SLRB.

A ranging and/or SL positioning QoS parameter may be identified by an AS, so that the AS configures or schedules the RB resources.

In some examples, after mapping the first information into the ranging and/or SL positioning QoS parameter, the ranging and/or SL positioning layer may pass the ranging and/or SL positioning QoS parameter mapped from the first information to the AS.

As an example, the ranging and/or SL positioning layer carries the ranging and/or SL positioning QoS parameter mapped from the first information in a first container and passes the first container to a V2X and/or ProSe layer, and the V2X and/or ProSe layer transparently passes the first container to the AS. In this example, the ranging and/or SL positioning QoS parameter is invisible to the V2X and/or ProSe layer. That is, the V2X and/or ProSe layer does not need to parse the content in the first container.

As another example, the ranging and/or SL positioning layer passes to the V2X and/or ProSe layer the ranging and/or SL positioning QoS parameter mapped from the first information, and the V2X and/or ProSe layer passes the ranging and/or SL positioning QoS parameter to the AS. In this example, the ranging and/or SL positioning QoS parameter is visible to the V2X and/or ProSe layer.

In some other examples, after mapping the first information into a QoS parameter of the RSPP data flow, the ranging and/or SL positioning layer may pass the QoS parameter of the RSPP data flow mapped from the first information to the AS.

For example, the ranging and/or SL positioning layer may pass to the V2X and/or ProSe layer the QoS parameter of the RSPP data flow mapped from the first information, and the V2X and/or ProSe layer passes the QoS parameter to the AS.

Particularly, different QoS parameters may correspond to the same RB configuration or to different RB configurations.

In the example of the present disclosure, the first information of the ranging and/or SL positioning service is mapped into the QoS parameter, the first information represents the QoS requirement for ranging and/or SL positioning, and the QoS parameter is used to configure or schedule RB resources. Therefore, it enables ranging and/or SL positioning QoS treatments in different scenarios.

FIG. 7 is a schematic flowchart illustrating an information handling method according to an example. The information handling method is applied to a terminal device. As illustrated in FIG. 7, the information handling method may include the following steps.

At step 201, a ranging and/or SL positioning layer maps first information of a ranging and/or SL positioning service into a ranging and/or SL positioning QoS parameter, where the first information represents a QoS requirement for ranging and/or SL positioning, and where the QoS parameter is used to configure or schedule RB resources.

At step 202, the ranging and/or SL positioning QoS parameter is carried in a first container and is passed to an AS.

In the example, the detailed descriptions about the first information, the QoS requirement and the RB resources please refer to the example above, which are not repeated here.

In some examples, the ranging and/or SL positioning QoS parameter includes: a target delay and/or a target accuracy of a ranging and/or SL positioning measurement result, and a range within which the target delay and/or the target accuracy is expected to be achieved.

The ranging and/or SL positioning measurement result may include: distance information and/or angle information and/or position information between a transmitting side terminal and a receiving side terminal for which the ranging and/or SL positioning is performed. The position information may include: a relative position and/or an absolute position between the transmitting side terminal and the receiving side terminal.

The ranging and/or SL positioning QoS parameter may be associated with a range between the transmitting side terminal and the receiving side terminal. Different types of ranging and/or SL positioning services may have different ranges.

The delay and/or the accuracy of the ranging and/or SL positioning measurement result are relative to a certain range. Generally, the larger the range, the lower the accuracy of the measurement result and the greater the delay. Conversely, the smaller the range, the higher the accuracy of the measurement result and the smaller the delay.

In the step 201, an application layer of the terminal device may include the first information of the ranging and/or SL positioning service in a service request and pass the service request to the ranging and/or SL positioning layer, and the ranging and/or SL positioning layer maps the first information into the ranging and/or SL positioning QoS parameter.

In some examples, the terminal device includes a universal integrated circuit card (UICC) pre-configured with the QoS parameter mapped from the first information. Alternatively, the QoS parameter mapped from the first information is configured by the terminal device. Alternatively, the QoS parameter mapped from the first information is configured by a network device.

In some examples, the QoS parameter mapped from the first information may be dynamically configured by the network device. The network device may be, for example, a PCF. The PCF may dynamically configure the QoS parameter mapped from the first information for the terminal device through a UE policy.

As an example, the ranging and/or SL positioning layer may map QoS requirement information of the ranging and/or SL positioning service into the QoS parameter. For example, the ranging and/or SL positioning layer may map the QoS requirement information of the ranging and/or SL positioning service into the corresponding QoS parameter according to a first mapping relationship between pieces of QoS requirement information and QoS parameters.

As an example, the ranging and/or SL positioning layer may map an application layer identifier of the ranging and/or SL positioning service into the QoS parameter. For example, the ranging and/or SL positioning layer may map the application layer identifier of the ranging and/or SL positioning service into the corresponding QoS parameter according to a second mapping relationship between application layer identifiers and QoS parameters.

It is to be understood that the terminal device may be pre-configured with the first mapping relationship and/or the second mapping relationship.

For example, the first mapping relationship and/or the second mapping relationship may be configured on the terminal device and stored in the UICC of the terminal device. The UICC may be, for example, a subscriber identity module (SIM).

Alternatively, the first mapping relationship and/or the second mapping relationship are received by the terminal device using an application layer signaling from the network device or another terminal device.

The first mapping relationship and/or the second mapping relationship may be stored in the terminal device in the form of a mapping table, a configuration file, or the like.

In the step 202, the ranging and/or SL positioning layer may carry the ranging and/or SL positioning QoS parameter in the first container and pass it transparently to the AS layer through the V2X and/or ProSe layer.

In some examples, the ranging and/or SL positioning QoS parameter may be included in the first container as the QoS parameter requested by a V2X and/or ProSe service.

The container may be understood as a carrier for carrying information. The information in the container is not to be parsed during the passing process until it reaches a destination.

In some examples, when receiving the first container sent by the ranging and/or SL positioning layer, the V2X and/or ProSe layer may pass the first container to the AS based on specified V2X service information or specified ProSe service information. Particularly, the specified V2X service information may be, for example, a specified V2X service type. The specified ProSe service information may be, for example, a specified ProSe service identifier.

In some other examples, when receiving the first container sent by the ranging and/or SL positioning layer, the V2X and/or ProSe layer may pass the first container to the AS based on indication information from the ranging and/or SL positioning layer.

In some other examples, upon receiving the first container sent by the ranging and/or SL positioning layer, the V2X and/or ProSe layer passes the first container to the AS.

In the example of the present disclosure, the first information of the ranging and/or SL positioning service is mapped into the ranging and/or SL positioning QoS parameter by the ranging and/or SL positioning layer, and the QoS parameter is carried in the first container and is passed to the AS. Therefore, it enables the ranging and/or SL positioning QoS treatments.

FIG. 8 is a schematic flowchart illustrating an information handling method according to an example. The information handling method is applied to a terminal device. As illustrated in FIG. 8, the information handling method may include the following step.

At step 301, a ranging and/or SL positioning layer provides a QoS parameter to a V2X and/or ProSe layer and indicates to the V2X and/or ProSe layer that the QoS parameter is a ranging and/or SL positioning QoS parameter, where the QoS parameter is used for the V2X and/or ProSe layer to pass to the AS, and where the QoS parameter is used to configure or schedule RB resources.

In the example, the detailed descriptions about the ranging and/or SL positioning QoS parameter, a QoS requirement and the RB resources please refer to the examples above, which are not repeated here.

In some examples, the QoS parameter provided by the ranging and/or SL positioning layer to the V2X and/or ProSe layer may be pre-configured.

For example, the QoS parameter is pre-configured in a UICC of the terminal device. Alternatively, the QoS parameter is configured by the terminal device. Alternatively, the QoS parameter is configured by a network device.

In the example, the ranging and/or SL positioning layer may provide the QoS parameter to the V2X and/or ProSe layer, and indicate to the V2X and/or ProSe layer that the QoS parameter is the ranging and/or SL positioning QoS parameter. When receiving the ranging and/or SL positioning QoS parameter sent by the ranging and/or SL positioning layer, the V2X and/or ProSe layer passes the QoS parameter to the AS. Therefore, it may enable the ranging and/or SL positioning QoS treatments.

FIG. 9 is a schematic flowchart illustrating an information handling method according to an example. The information handling method is applied to a terminal device. As illustrated in FIG. 9, the information handling method may include the following step.

At step 401, a V2X and/or ProSe layer passes a first container from a ranging and/or SL positioning layer to an AS based on a V2X service type or a ProSe service identifier, where the first container carries a ranging and/or SL positioning QoS parameter and where the QoS parameter is used to configure or schedule RB resources.

The ranging and/or SL positioning QoS parameter may be a QoS parameter mapped from first information of a ranging and/or SL positioning service. The first information of the ranging and/or SL positioning service represents a QoS requirement for ranging and/or SL positioning.

In the example, the detailed descriptions about the first information, the ranging and/or SL positioning QoS parameter and the RB resources please refer to the examples above, which are not repeated here.

In some examples, when the V2X and/or ProSe layer receives the first container sent by the ranging and/or SL positioning layer in the step 401, the V2X and/or ProSe layer may pass the first container to the AS based on the V2X service type or the ProSe service identifier.

In some examples, the V2X and/or ProSe layer may pass the first container from the ranging and/or SL positioning layer to the AS based on a specified V2X service type or a specified ProSe service identifier.

The specified V2X service type or the specified ProSe service identifier may be specified by a protocol or configured by a communication device. For example, V2X Service Type A is dedicated to Application B supporting the ranging and/or SL positioning service, and V2X Service Type A may be used for mapping with Application B supporting the ranging and/or SL positioning service.

As an example, the ranging and/or SL positioning layer maps an application identifier of the ranging and/or SL positioning service into the V2X service type or the ProSe service identifier, and passes the first container and the V2X service type or the ProSe service identifier mapped from the application identifier to the V2X and/or ProSe layer. If the V2X and/or ProSe layer determines that the received V2X service type is the specified V2X service type or the received ProSe service identifier is the specified ProSe service identifier, the V2X and/or ProSe layer passes the first container to the AS, otherwise it does not pass the first container to the AS.

For example, assuming that three V2X service types are specified in the V2X and/or ProSe layer, namely V2X Service Type 1, V2X Service Type 2 and V2X Service Type 3, the V2X and/or ProSe layer passes the first container to the AS if the V2X service type received from the ranging and/or SL positioning layer is V2X Service Type 2, and does not pass the first container to the AS if the V2X service type received from the ranging and/or SL positioning layer is V2X Service Type 4.

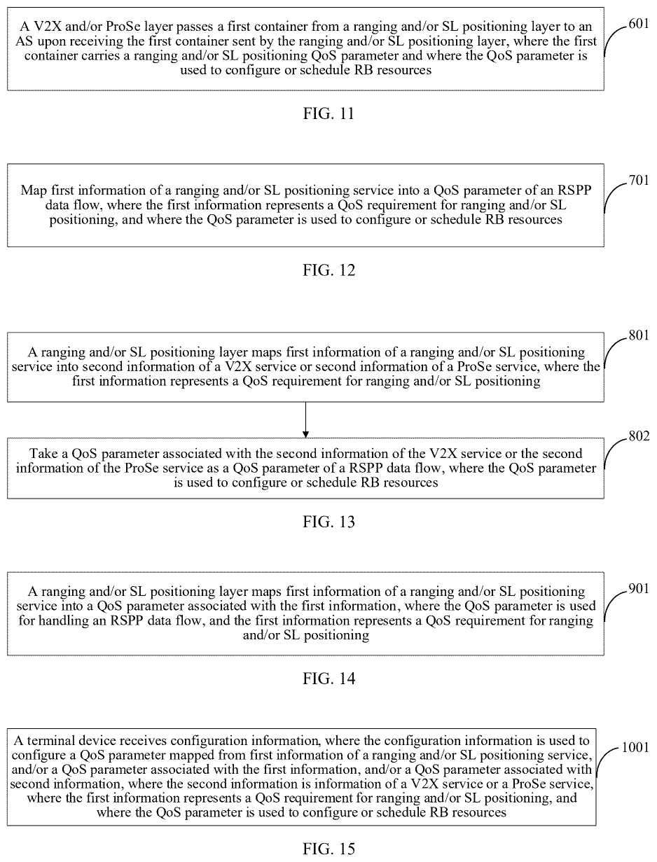

FIG. 10 is a schematic flowchart illustrating an information handling method according to an example. The information handling method is applied to a terminal device. As illustrated in FIG. 10, the information handling method may include the following step.

At step 501, a V2X and/or ProSe layer passes a first container from a ranging and/or SL positioning layer to an AS based on indication information from the ranging and/or SL positioning layer, where the first container carries a ranging and/or SL positioning QoS parameter and where the QoS parameter is used to configure or schedule RB resources.

The ranging and/or SL positioning QoS parameter may be a QoS parameter mapped from first information of a ranging and/or SL positioning service. The first information of the ranging and/or SL positioning service represents a QoS requirement for ranging and/or SL positioning.

In the example, the detailed descriptions about the first information, the ranging and/or SL positioning QoS parameter and the RB resources please refer to the examples above, which are not repeated here.

Particularly, the indication information indicates whether the V2X and/or ProSe layer passes the first container to the AS. The indication information may be an indicator. For example, the indicator being “1” indicates that the first container is passes to the AS, and the indicator being “0” indicates that the first container is not passes to the AS.

In the example, the ranging and/or SL positioning layer sends the first container and the indication information to the V2X and/or ProSe layer. If the indication information indicates the V2X and/or ProSe layer to provide the first container to the AS layer, the V2X and/or ProSe layer provides the first container to the AS layer. If the indication information indicates the V2X and/or ProSe layer not to provide the first container to the AS layer, the V2X and/or ProSe layer does not provide the first container to the AS layer.

FIG. 11 is a schematic flowchart illustrating an information handling method according to an example. The information handling method is applied to a terminal device. As illustrated in FIG. 11, the information handling method may include the following step.

At step 601, a V2X and/or ProSe layer passes a first container from a ranging and/or SL positioning layer to an AS upon receiving the first container sent by the ranging and/or SL positioning layer, where the first container carries a ranging and/or SL positioning QoS parameter and where the QoS parameter is used to configure or schedule RB resources.

The ranging and/or SL positioning QoS parameter may be a QoS parameter mapped from first information of a ranging and/or SL positioning service. The first information of the ranging and/or SL positioning service represents a QoS requirement for ranging and/or SL positioning.

In the example, the detailed descriptions about the first information, the ranging and/or SL positioning QoS parameter and the RB resources please refer to the examples above, which are not repeated here.

In the example, the ranging and/or SL positioning layer sends the first container to the V2X and/or ProSe layer. Once the V2X and/or ProSe layer receives the first container, it passes the first container to the AS. Therefore, it enables the AS to use the QoS parameter to configure or schedule the RB resources.

FIG. 12 is a schematic flowchart illustrating an information handling method according to an example. The information handling method is applied to a terminal device. As illustrated in FIG. 12, the information handling method may include the following step.

At step 701, first information of a ranging and/or SL positioning service is mapped into a QoS parameter of an RSPP data flow, where the first information represents a QoS requirement for ranging and/or SL positioning, and where the QoS parameter is used to configure or schedule RB resources.

In the example, the detailed descriptions about the first information, the QoS parameter of the RSPP data flow and the RB resources please refer to the examples above, which are not repeated here.

The QoS parameter of the RSPP data flow may be identified by the AS and thus is used for the AS to configure or schedule the RB resources.

In some examples, in the step 701, the ranging and/or SL positioning layer maps the first information of the ranging and/or SL positioning service into the QoS parameter of the RSPP data flow.

An application layer of the terminal device may include the first information in a ranging and/or SL positioning service request and pass the service request to the ranging and/or SL positioning layer, and the ranging and/or SL positioning layer maps the first information into the QoS parameter of the RSPP data flow.

As an example, the ranging and/or SL positioning layer may map QoS requirement information of the ranging and/or SL positioning service into the QoS parameter of the RSPP data flow.

As an example, the ranging and/or SL positioning layer may map an application layer identifier of the ranging and/or SL positioning service into the QoS parameter of the RSPP data flow.

In the example of the present disclosure, the first information of the ranging and/or SL positioning service is mapped into the QoS parameter of the RSPP data flow by the ranging and/or SL positioning layer. Therefore, it enables the QoS handling for the RSPP data flow.

FIG. 13 is a schematic flowchart illustrating an information handling method according to an example. The information handling method is applied to a terminal device. As illustrated in FIG. 13, the information handling method may include the following steps.

At step 801, a ranging and/or SL positioning layer maps first information of a ranging and/or SL positioning service into second information of a V2X service or second information of a ProSe service, where the first information represents a QoS requirement for ranging and/or SL positioning.

At step 802, a QoS parameter associated with the second information of the V2X service or the second information of the ProSe service is taken as a QoS parameter of a RSPP data flow, where the QoS parameter is used to configure or schedule RB resources.

In the example, the detailed descriptions about the first information, the QoS parameter of the RSPP data flow and the RB resources please refer to the examples above, which are not repeated here.

In some examples, the second information of the V2X service includes at least one of the following: a V2X service identifier (SID) or a V2X service type.

In some examples, the second information of the ProSe service includes at least one of the following: a ProSe service identifier or a ProSe service type.

In some examples, the terminal device includes a UICC pre-configured with the QoS parameter associated with the second information. Alternatively, the QoS parameter associated with the second information is configured by the terminal device. Alternatively, the QoS parameter associated with the second information is configured by a network device.

In some examples, the QoS parameter associated with the second information may be dynamically configured by the network device. The network device may be, for example, a PCF. The PCF may dynamically configure the QoS parameter associated with the second information for the terminal device through a UE policy.

As an example, the ranging and/or SL positioning layer may map QoS requirement information of the ranging and/or SL positioning service to the V2X service type or the ProSe service identifier, and take the QoS parameter associated with the V2X service type or the ProSe service identifier as the QoS parameter of the RSPP data flow.

As an example, the ranging and/or SL positioning layer may map an application layer identifier of the ranging and/or SL positioning service into the V2X service type or the ProSe service identifier, and take the QoS parameter associated with the V2X service type or the ProSe service identifier as the QoS parameter of the RSPP data flow.

In the example of the disclosure, the ranging and/or SL positioning layer maps the first information of the ranging and/or SL positioning service to the second information of the V2X service or the second information of the ProSe service. Therefore, the V2X and/or ProSe layer may take the QoS parameter associated with the second information of the V2X service or the second information of the ProSe service as the QoS parameter of the RSPP data flow, thereby enabling the QoS handling for the RSPP data flow.

FIG. 14 is a schematic flowchart illustrating an information handling method according to an example. The information handling method is applied to a terminal device. As illustrated in FIG. 14, the information handling method may include the following step.

At step 901, a ranging and/or SL positioning layer maps first information of a ranging and/or SL positioning service into a QoS parameter associated with the first information, where the QoS parameter is used for handling an RSPP data flow, and the first information represents a QoS requirement for ranging and/or SL positioning.

The QoS parameter may be used to configure or schedule RB resources.

In the example, the detailed descriptions about the first information, the QoS parameter and the RB resources please refer to the examples above, which are not repeated here.

In some examples, the terminal device includes a UICC pre-configured with the QoS parameter associated with the first information. Alternatively, the QoS parameter associated with the first information is configured by the terminal device. Alternatively, the QoS parameter associated with the first information is configured by a network device.

In some examples, the QoS parameter associated with the first information may be dynamically configured by the network device. The network device may be, for example, a PCF. The PCF may dynamically configure the QoS parameter associated with the first information for the terminal device through a UE policy.

As an example, the ranging and/or SL positioning layer may map QoS requirement information or an application layer identifier of the ranging and/or SL positioning service into a QoS parameter associated with the application layer identifier.

As an example, the ranging and/or SL positioning layer may map the QoS requirement information or the application layer identifier of the ranging and/or SL positioning service into a QoS parameter associated with the QoS requirement information.

In the example of the present disclosure, the ranging and/or SL positioning layer maps the first information into the QoS parameter associated with the first information. Therefore, the V2X and/or ProSe layer may take the QoS parameter associated with the first information as the QoS parameter of the RSPP data flow, thereby enabling the QoS handling for the RSPP data flow.

FIG. 15 is a schematic flowchart illustrating an information handling method according to an example. As illustrated in FIG. 15, the information handling method may include the following step.

At step 1001, a terminal device receives configuration information, where the configuration information is used to configure a QoS parameter mapped from first information of a ranging and/or SL positioning service, and/or a QoS parameter associated with the first information, and/or a QoS parameter associated with second information, where the second information is information of a V2X service or a ProSe service, where the first information represents a QoS requirement for ranging and/or SL positioning, and where the QoS parameter is used to configure or schedule RB resources.

The terminal device supports ranging and/or SL positioning. The terminal device may include but is not limited to a mobile phone, a drone, a car, a smart home appliance or any IoT device, etc.

In the example, the detailed descriptions about the first information, the second information, the QoS parameter and the RB resources please refer to the examples above, which are not repeated here.

In some examples, the terminal device may receive the configuration information sent by a network device.

In some examples, the QoS parameter mapped from the first information is a ranging and/or SL positioning QoS parameter. That is, the QoS parameter mapped from the first information may include: a target delay and a target accuracy of a ranging and/or SL positioning measurement result (distance and direction), and a range within which the target delay and/or the target accuracy is expected to be achieved.

In some examples, the QoS parameter associated with the second information is used for the QoS handling for a RSPP data flow.

In some examples, the QoS parameter associated with the first information is used for the QoS handling for the RSPP data flow.

In the example of the present disclosure, the QoS parameter may be dynamically configured by the network device.

In some examples, the network device may be a core network device such as a PCF. The PCF may send configuration information to the terminal device.

In some examples, the configuration information is included in a UE policy sent by the PCF to the terminal device.

In the example, the terminal device receives the configuration information, so that the terminal device may configure the QoS parameter for ranging and/or SL positioning QoS treatment based on the configuration information. Therefore, it enables the QoS handling for the ranging and/or SL positioning service.

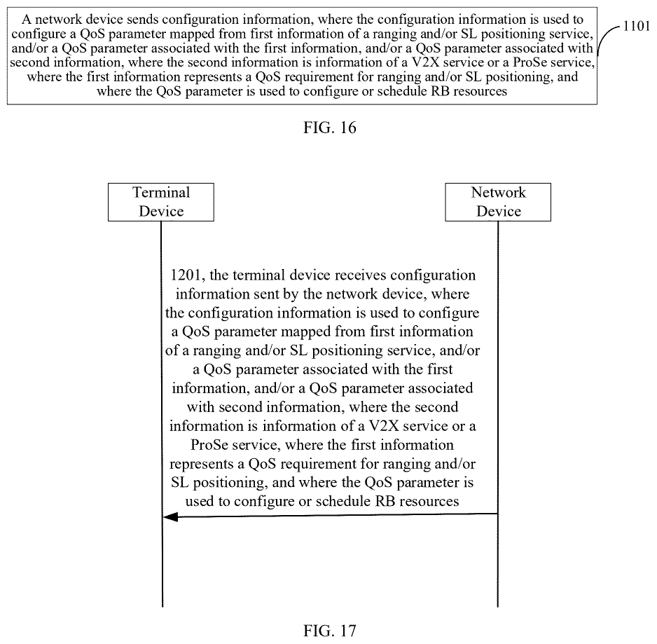

FIG. 16 is a schematic flowchart illustrating an information handling method according to an example. As illustrated in FIG. 16, the information handling method may include the following step.

At step 1101, a network device sends configuration information, where the configuration information is used to configure a QoS parameter mapped from first information of a ranging and/or SL positioning service, and/or a QoS parameter associated with the first information, and/or a QoS parameter associated with second information, where the second information is information of a V2X service or a ProSe service, where the first information represents a QoS requirement for ranging and/or SL positioning, and where the QoS parameter is used to configure or schedule RB resources.

In the example, the detailed descriptions about the first information, the second information, the QoS parameter and the RB resources please refer to the examples above, which are not repeated here.

In the example, the network device sends the configuration information, so that the terminal device, after receiving the configuration information, may configure the QoS parameter for a ranging and/or SL positioning QoS treatment based on the configuration information. Therefore, it enables the QoS handling for the ranging and/or SL positioning service.

FIG. 17 is a schematic flowchart illustrating an information handling method according to an example. As illustrated in FIG. 17, the information handling method may include the following step.

At step 1201, a terminal device receives configuration information sent by a network device, where the configuration information is used to configure a QoS parameter mapped from first information of a ranging and/or SL positioning service, and/or a QoS parameter associated with the first information, and/or a QoS parameter associated with second information, where the second information is information of a V2X service or a ProSe service, where the first information represents a QoS requirement for ranging and/or SL positioning, and where the QoS parameter is used to configure or schedule RB resources.

In the example, the detailed descriptions about the first information, the second information, the QoS parameter and the RB resources please refer to the examples above, which are not repeated here.

In the example, the terminal device receives the configuration information sent by the network device, so that the terminal device may configure the QoS parameter for the ranging and/or SL positioning QoS treatment based on the configuration information. Therefore, it enables the QoS handling for the ranging and/or SL positioning service.

An example of the present disclosure provides a communication system, which may include a terminal device and a network device.

The network device is configured to send configuration information to the terminal device. The configuration information is used to configure a QoS parameter mapped from first information of a ranging and/or SL positioning service, and/or a QoS parameter associated with the first information, and/or a QoS parameter associated with second information. The second information is information of a V2X service or a ProSe service. Particularly, the first information represents a QoS requirement for ranging and/or SL positioning. The QoS parameter is used to configure or schedule RB resources.

The terminal device receives the configuration information.

In the example, the detailed descriptions about the first information, the second information, the QoS parameter and the RB resources please refer to the examples above, which are not repeated here.

To further explain any example of the present disclosure, a few detailed examples are given below.

Ranging and/or SL positioning are expected to support commercial, V2X and public safety scenarios. The QoS treatments in different scenarios are different.

A ranging and/or SL positioning application identifier is a globally unique identifier that identifies a specific ranging and/or SL positioning application, and may be mapped into a V2X service type or a ProSe identifier.

An example of the present disclosure provides an information handling method, which supports a QoS handling for a ranging/SL positioning QoS requirement.

The ranging/SL positioning QoS requirement includes a delay/accuracy of a ranging/SL positioning result (distance and direction).

The ranging/SL positioning QoS requirement is included in a ranging/SL positioning service request generated by an application layer and is provided by the application layer to a ranging/SL positioning layer.

The ranging/SL positioning layer maps the QoS requirement into a PC5 QoS parameter that is capable of being recognized by an AS layer, contains the QoS parameter taken as a parameter of a V2X/ProSe service request in a container and provides it to a V2X/ProSe layer.

The V2X/ProSe layer has three options to determine whether to provide the container containing the QoS parameter to the AS layer.

Option 1, the container containing the QoS parameter is provided to the AS layer based on a V2X service type/a ProSe identifier. The V2X service type/the ProSe identifier may be used to identify (or map) a ranging/SL positioning application.

Option 2, the ranging/SL positioning layer sends the container and an indication. The indication indicates the provision of the container to the AS layer. The V2X/ProSe layer provides the container to the AS layer according to the indication.

Option 3, the V2X/ProSe layer provides the container to the AS layer once receiving the container from the ranging/SL positioning layer.

Alternatively, the ranging/SL positioning layer may provide a PC5 QoS parameter to the V2X/ProSe layer, indicating that it is the ranging/SL positioning QoS parameter, and then the V2X/ProSe layer sends it to the AS layer.

An example of the present disclosure provides an information handling method, which supports a QoS handling for an RSPP data flow.

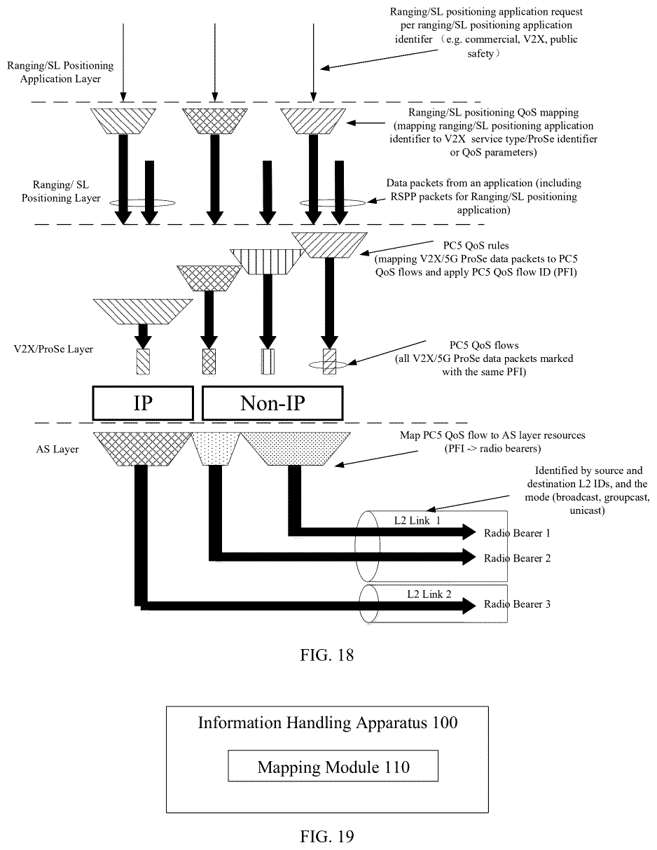

As illustrated in FIG. 18, the information handling method may include the following steps.

A ranging and/or SL positioning application layer receives a ranging and/or SL positioning service request and transmits the ranging and/or SL positioning service request to a ranging and/or SL positioning layer. The service request carries a ranging and/or SL positioning application identifier.

The ranging and/or SL positioning layer maps the ranging and/or SL positioning application identifier (e.g., commercial, V2X, public safety) into a V2X service type or a ProSe identifier. The V2X service type or the ProSe identifier is associated with a set of PC5 QoS parameters (e.g., a PQI, a PC5 traffic bit rate, a PC5 link aggregation bit rate, and a range). The V2X/ProSe layer handles an RSPP data flow as V2X/ProSe application data packets for the QoS treatment. Different ranging and/or SL positioning application identifiers may be mapped into the same or different V2X service types or ProSe identifiers.

Alternatively, the ranging and/or SL positioning layer maps the ranging and/or SL positioning application identifier into PC5 QoS parameters (e.g., the PQI, the PC5 flow bit rate, the PC5 link aggregation bitrate, and the range). In this case, the UE may be configured with a set of PC5 QoS parameters used for identifying the ranging and/or SL positioning application. The ranging and/or SL positioning layer provides the PC5 QoS parameters to the V2X and/or ProSe layer. The V2X/ProSe layer handles the RSPP data flow using the PC5 QoS parameters received from the ranging and/or SL positioning layers for the QoS treatment.

An AS layer handles the QoS of the RSPP data flow using the same mechanism as for the V2X and/or ProSe application data packets.

The beneficial effects brought by the technical solutions disclosed in the present disclosure include: supporting the QoS handling for the QoS requirement for ranging and/or SL positioning and the QoS handling for the RSPP transport, with minimal impact on the existing V2X and/or ProSe QoS mechanism.

FIG. 19 is a schematic structural diagram illustrating an information handling apparatus according to an example. The information handling apparatus is applied to a terminal device. As illustrated in FIG. 19, the information handling apparatus 100 may include a mapping module 110.

The mapping module 110 is configured to map first information of a ranging and/or SL positioning service into a QoS parameter, where the first information represents a QoS requirement for ranging and/or SL positioning, and where the QoS parameter is used to configure or schedule RB resources.

In an example, the first information includes: QoS requirement information of the ranging and/or SL positioning service; and/or an application identifier of the ranging and/or SL positioning service.

In an example, the QoS requirement information includes: a target delay and/or a target accuracy of a ranging and/or SL positioning measurement result, and a range within which the target delay and/or the target accuracy is expected to be achieved.

In an example, the mapping module 110 is configured to: map, by a ranging and/or SL positioning layer, the first information into a ranging and/or SL positioning QoS parameter, and pass the ranging and/or SL positioning QoS parameter carried in a first container to an AS; or provide, by the ranging and/or SL positioning layer, the QoS parameter to a V2X and/or ProSe layer, and indicate to the V2X and/or ProSe layer that the QoS parameter is the ranging and/or SL positioning QoS parameter, where the QoS parameter is passed by the V2X and/or ProSe layer to the AS.

In an example, the terminal device includes a UICC pre-configured with the QoS parameter mapped from the first information.

Alternatively, the QoS parameter mapped from the first information is configured by the terminal device.

Alternatively, the QoS parameter mapped from the first information is configured by a network device.

In an example, the apparatus further includes a passing module. The passing module is configured to: pass, by the V2X and/or ProSe layer, the first container from the ranging and/or SL positioning layer to the AS based on a V2X service type or a ProSe service identifier; or pass, by the V2X and/or ProSe layer, the first container from the ranging and/or SL positioning layer to the AS based on indication information from the ranging and/or SL positioning layer; or pass, by the V2X and/or ProSe layer, the first container from the ranging and/or SL positioning layer to the AS upon receiving the first container sent by the ranging and/or SL positioning layer.

In an example, the ranging and/or SL positioning QoS parameter includes: a target delay and/or a target accuracy of a ranging and/or SL positioning measurement result, and a range within which the target delay and/or the target accuracy is expected to be achieved.

In an example, the mapping module 110 is configured to: map the first information of the ranging and/or SL positioning service into a QoS parameter of an RSPP data flow.

In an example, the mapping module 110 is configured to: map, by the ranging and/or SL positioning layer, the first information into second information of a V2X service or second information of a ProSe service, and take a QoS parameter associated with the second information of the V2X service or the second information of the ProSe service as the QoS parameter of the RSPP data flow; or map, by the ranging and/or SL positioning layer, the first information into a QoS parameter associated with the first information, where the QoS parameter is used for handling the RSPP data flow.

In an example, the terminal device includes a UICC pre-configured with the QoS parameter associated with the first information or the second information.

Alternatively, the QoS parameter associated with the first information or the second information is configured by the terminal device.

Alternatively, the QoS parameter associated with the first information or the second information is configured by a network device.

In an example, the second information of the V2X service includes at least one of the following: a V2X service identifier or a V2X service type.

The second information of the ProSe service includes at least one of the following: a ProSe service identifier or a ProSe service type.

In an example, the QoS parameter of the RSPP data flow include at least one of the following: a PQI; a PC5 flow bit rate; a PC5 link aggregation bit rate; or a range.

With respect to the apparatuses in the foregoing examples, the detailed manner in which each module performs its operation has been described in detail in the examples of the related methods, and will not be described in detail here.

An example of the present disclosure provides a communication device, including: one or more memories for storing instructions executable by one or more processors; and the one or more processors connected to the one or more memory individually.

The one or more processors are configured to perform the information handling method provided by any of the aforementioned technical solutions.

The one or more processors may include a storage medium of various types. The storage medium is a non-transitory computer storage medium that is capable of keeping information thereon stored after the communication device is powered off.

The communication device includes a UE or a network device.

The one or more processors may be connected to the one or more memories through a bus or the like, and are used to read an executable program stored on the one or more memories, for example, at least one of the information handling methods illustrated in FIG. 6 to FIG. 18.

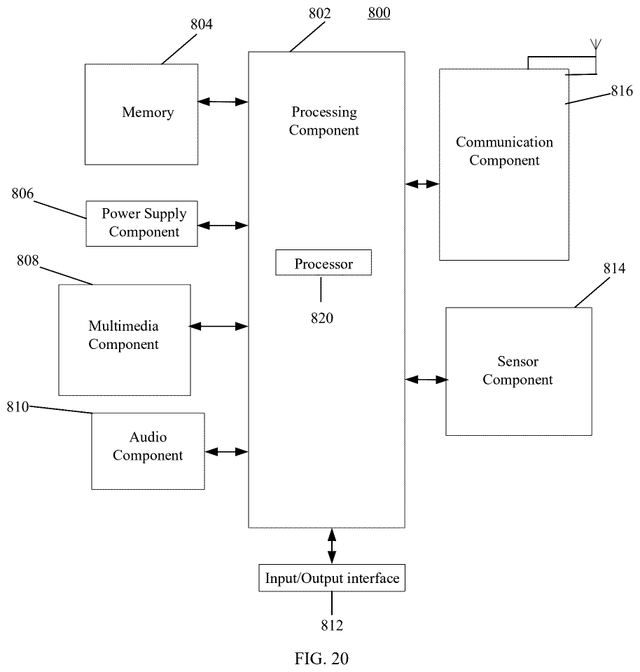

FIG. 20 illustrates a block diagram of a UE 800 according to an example. For example, the UE 800 may be a drone, a mobile phone, a computer, a digital broadcasting user device, a messaging device, a game console, a tablet device, a personal digital assistant, and the like.

Referring to FIG. 20, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operations of UE 800 such as operations associated with display, phone calls, data communications, camera operations, and recording operations. The processing component 802 may include one or more processors 820 to execute instructions to generate all or a part of the steps of the foregoing methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data to support the operations of UE 800. Examples of such data include instructions for any application or method operated on UE 800 contact data, phonebook data, messages, pictures, videos, and the like. The memory 804 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 806 provides power for various components of UE 800. The power supply component 806 may include a power management system, one or more power supplies, and other components associated with generating, managing, and distributing power for the UE 800.

The multimedia component 808 includes a screen providing an output interface between UE 800 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some examples, the multimedia component 808 includes a front camera and/or a rear camera. The front camera and/or rear camera may receive external multimedia data when UE 800 is in an operating mode, such as a photographing mode or a video mode. Each of the front and rear cameras may be a fixed optical lens system or have focal length and optical zooming capability.

The audio component 810 is configured to output and/or input an audio signal. For example, the audio component 810 includes a microphone (MIC) that is configured to receive an external audio signal when the UE 800 is in an operating mode, such as a call mode, a recording mode, and a voice recognition mode. The received audio signal may be further stored in memory 804 or transmitted via communication component 816. In some examples, the audio component 810 also includes a speaker for outputting an audio signal.

The I/O interface 812 provides an interface between the processing component 802 and a peripheral interface module. The peripheral interface module may be a keyboard, a click wheel, buttons, or the like. These buttons may include but not limited to a home button, a volume button, a start button and a lock button.

The sensor component 814 includes one or more sensors to provide the UE 800 with state assessments in various aspects. For example, the sensor component 814 may detect an open/closed state of the device 800 and a relative positioning of components such as the display and keypad of UE 800, and the sensor component 814 may also detect a change in position of UE 800 or a component of UE 800, the presence or absence of a user contacting with UE 800, orientation or acceleration/deceleration of UE 800, and temperature change of UE 800. The sensor component 814 may include a proximity sensor configured to detect the presence of a nearby object without any physical contact. The sensor component 814 may also include a light sensor, such as a complementary metal oxide semiconductor (CMOS) or a charge-coupled device (CCD) image sensor, for being applied in imaging applications. In some examples, the sensor component 814 may also include an acceleration sensor, a gyro sensor, a magnetic sensor, a pressure sensor, or a temperature sensor.

The communication component 816 is configured to facilitate wired or wireless communication between UE 800 and other devices. UE 800 may access a wireless network based on a communication standard, such as WiFi, 2G, 3G, 4G, 5G, 6G or a combination thereof. In an example, the communication component 816 receives broadcast signals or broadcast related information from an external broadcast management system via a broadcast channel. In an example, the communication component 816 also includes a near field communication (NFC) module to facilitate short-range communication. For example, the NFC module may be implemented based on a radio frequency identifier (RFID) technology, an infrared data association (IrDA) technology, an ultra-wideband (UWB) technology, a Bluetooth® (BT) technology and other technologies.

In one or more examples, the UE 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronics to perform the foregoing information handling methods applied to the UE.

In one or more examples, there is also provided a non-transitory computer-readable storage medium including instructions, such as the memory 804 including instructions. These instructions may be executed by the one or more processors 820 of the UE 800 to generate the foregoing information handling methods. For example, the non-transitory computer-readable storage medium may be an ROM, a random access memory (RAM), a CD-ROM, a magnetic tape, a floppy disk, an optical data storage device, and the like.

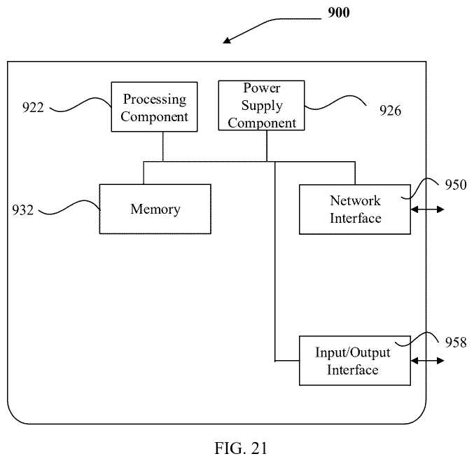

As illustrated in FIG. 21, an example of the present disclosure illustrates a structure of a communication device. For example, the communication device 900 may be provided as a device on a network side. The communication device may be a core network device.

Referring to FIG. 21, the communication device 900 includes a processing component 922 which further includes one or more processors, and a memory resource represented by a memory 932 which is used to store instructions that may be executed by the processing component 922, such as application programs. The application programs stored in the memory 932 may include one or more modules, each of which corresponds to a set of instructions. In addition, the processing component 922 is configured to execute instructions to perform the aforementioned information handling methods.

The communication device 900 may also include a power supply component 926 which is configured to perform power management for the communication device 900, a wired or wireless network interface 950 which is configured to connect the communication device 900 to a network, and an input/output (I/O) interface 958. The communication device 900 may operate based on an operating system stored in memory 932, such as Windows Server™, Mac OS X™, Unix™, Linux™, FreeBSD™, or the like.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the true scope and spirit of the present disclosure are set forth in the appended claims.

It is to be understood that the present disclosure is not limited to the precise structures described above and illustrated in the accompanying drawings, and that various modifications and changes may be made without departing from the scope thereof. The scope of the present disclosure is to be limited only by the appended claims.

1. An information handling method, applied to a terminal device, comprising:
mapping first information of a ranging and/or sidelink (SL) positioning service into a quality of service (QOS) parameter, wherein the first information represents a QoS requirement for ranging and/or SL positioning, and wherein the QoS parameter is used to configure or schedule radio bearer (RB) resources.

2. The method according to claim 1, wherein the first information comprises at least one of:
QOS requirement information of the ranging and/or SL positioning service; and/or or
an application identifier of the ranging and/or SL positioning service.

3. The method according to claim 2, wherein the QoS requirement information comprises:
at least one of a target delay and/or or a target accuracy of a ranging and/or SL positioning measurement result, and
a range within which the at least one of the target delay and/or or the target accuracy is expected to be achieved.

4. The method according to any claim 1, wherein mapping the first information of the ranging and/or SL positioning service into the QoS parameter comprises:
mapping, by a ranging and/or SL positioning layer, the first information into a ranging and/or SL positioning QoS parameter, and passing the ranging and/or SL positioning QoS parameter carried in a first container to an access stratum (AS); or
providing, by the ranging and/or SL positioning layer, the QoS parameter to a vehicle to everything (V2X) and/or proximity service (ProSe) layer, and indicating to the V2X and/or ProSe layer that the QoS parameter is the ranging and/or SL positioning QOS parameter, wherein the QoS parameter is passed by the V2X and/or ProSe layer to the AS.

5. The method according to claim 4,
wherein the terminal device comprises a universal integrated circuit card (UICC) pre-configured with the QoS parameter mapped from the first information; or
wherein the QoS parameter mapped from the first information is configured by the terminal device; or
wherein the QoS parameter mapped from the first information is configured by a network device.

6. The method according to claim 4, wherein passing the ranging and/or SL positioning QoS parameter carried in the first container to the AS comprises:
passing, by the V2X and/or ProSe layer, the first container from the ranging and/or SL positioning layer to the AS based on a V2X service type or a ProSe service identifier; or
passing, by the V2X and/or ProSe layer, the first container from the ranging and/or SL positioning layer to the AS based on indication information from the ranging and/or SL positioning layer; or
passing, by the V2X and/or ProSe layer, the first container from the ranging and/or SL positioning layer to the AS upon receiving the first container sent by the ranging and/or SL positioning layer.

7. The method according to claim 4, wherein the ranging and/or SL positioning QoS parameter comprises:
at least one of a target delay and/or or a target accuracy of a ranging and/or SL positioning measurement result, and
a range within which the at least one of the target delay and/or or the target accuracy is expected to be achieved.

8. The method according to claim 1, wherein mapping the first information of the ranging and/or SL positioning service into the QoS parameter comprises:
mapping the first information of the ranging and/or SL positioning service into a QoS parameter of a ranging and/or SL positioning protocol (RSPP) data flow.

9. The method according to claim 8, wherein mapping the first information of the ranging and/or SL positioning service into the QoS parameter of the RSPP data flow comprises:
mapping, by a ranging and/or SL positioning layer, the first information into second information of a vehicle to everything (V2X) service or second information of a proximity service (ProSe) service, and taking a QoS parameter associated with the second information of the V2X service or the second information of the ProSe service as the QoS parameter of the RSPP data flow; or
mapping, by the ranging and/or SL positioning layer, the first information into a QoS parameter associated with the first information, wherein the QoS parameter associated with the first information is used for handling the RSPP data flow.

10. The method according to claim 9,
wherein the terminal device comprises a universal integrated circuit card (UICC) pre-configured with the QoS parameter associated with the first information or the second information; or
wherein the QoS parameter associated with the first information or the second information is configured by the terminal device; or
wherein the QoS parameter associated with the first information or the second information is configured by a network device.

11. The method according to claim 9,
wherein the second information of the V2X service comprises at least one of the-a V2X service identifier; or
a V2X service type;
wherein the second information of the ProSe service comprises at least one of-the-following:
a ProSe service identifier; or
a ProSe service type.

12. The method according to claim 8, wherein the QoS parameter of the RSPP data flow comprises at least one of:
a 5th generation QoS indicator (PQI);
a PC5 flow bit rate;
a PC5 link aggregation bit rate; or
a range.

13.-24. (canceled)

25. A communication device, comprising:
one or more processors; and
one or more memories storing an executable program executable by the one or more processors;
wherein the one or more processors are configured to:
map first information of a ranging and/or sidelink (SL) positioning service into a quality of service (QOS) parameter, wherein the first information represents a QoS requirement for ranging and/or SL positioning, and wherein the QoS parameter is used to configure or schedule radio bearer (RB) resources.

26. A non-transitory computer storage medium, storing an executable program, wherein the executable program, when executed by one or more processors, causes the one or more processors to perform:
mapping first information of a ranging and/or sidelink (SL) positioning service into a quality of service (QOS) parameter, wherein the first information represents a QoS requirement for ranging and/or SL positioning, and wherein the QoS parameter is used to configure or schedule radio bearer (RB) resources.

27. The communication device according to claim 25, wherein the first information comprises at least one of:
QOS requirement information of the ranging and/or SL positioning service; or an application identifier of the ranging and/or SL positioning service.

28. The communication device according to claim 27, wherein the QoS requirement information comprises:
at least one of a target delay or a target accuracy of a ranging and/or SL positioning measurement result, and
a range within which the at least one of the target delay or the target accuracy is expected to be achieved.

29. The communication device according to claim 25, wherein the one or more processors are further configured to:
map, by a ranging and/or SL positioning layer, the first information into a ranging and/or SL positioning QoS parameter, and pass the ranging and/or SL positioning QoS parameter carried in a first container to an access stratum (AS); or
provide, by the ranging and/or SL positioning layer, the QoS parameter to a vehicle to everything (V2X) and/or proximity service (ProSe) layer, and indicate to the V2X and/or ProSe layer that the QoS parameter is the ranging and/or SL positioning QoS parameter, wherein the QoS parameter is passed by the V2X and/or ProSe layer to the AS.

30. The communication device according to claim 29, wherein the one or more processors are further configured to:
pass, by the V2X and/or ProSe layer, the first container from the ranging and/or SL positioning layer to the AS based on a V2X service type or a ProSe service identifier; or
pass, by the V2X and/or ProSe layer, the first container from the ranging and/or SL positioning layer to the AS based on indication information from the ranging and/or SL positioning layer; or
pass, by the V2X and/or ProSe layer, the first container from the ranging and/or SL positioning layer to the AS upon receiving the first container sent by the ranging and/or SL positioning layer.

31. The communication device according to claim 25, wherein the one or more processors are further configured to:
map the first information of the ranging and/or SL positioning service into a QoS parameter of a ranging and/or SL positioning protocol (RSPP) data flow.

32. The communication device according to claim 31, wherein the one or more processors are further configured to:
map, by a ranging and/or SL positioning layer, the first information into second information of a vehicle to everything (V2X) service or second information of a proximity service (ProSe) service, and take a QoS parameter associated with the second information of the V2X service or the second information of the ProSe service as the QOS parameter of the RSPP data flow; or
map, by the ranging and/or SL positioning layer, the first information into a QoS parameter associated with the first information, wherein the QoS parameter associated with the first information is used for handling the RSPP data flow.
